(19) United States
(12) Patent Application Publication
(10) Pub. No.: US 2026/0312460 A1
(43) Pub. Date: Oct. 8, 2026

(54) A GENERATOR FOR USE IN A WIND TURBINE

(71) Applicant: Vestas Wind Systems A/S, Aarhus N (DK)

(72) Inventors: Peter P. Mongeau, Center Conway, NH (US); Lars Langvardt Krogh, Egå (DK)

(73) Assignee: Vestas Wind Systems A/S, Aarhus N (DK)

(21) Appl. No.: 19/484,422

(22) PCT Filed: May 3, 2024
(86) PCT No.: PCT/DK2024/050106

§ 371 Date: Nov. 14, 2025

Related U.S. Application Data
(60) Provisional application No. 63/502,728, filed on May 17, 2023.

(30) Foreign Application Priority Data
Jul. 3, 2023 (DK) PA202370352

(51) Int. Cl. H02K 7/18; F03D 9/25; H02K 1/32

(52) U.S. Cl. CPC H02K 7/1838; F03D 9/25; H02K 1/32; F05B 2220/706

(57) ABSTRACT

A generator rotor for a wind turbine, comprising a cylindrical ring structure defining a radially inner surface and a central hollow portion, and being arranged to rotate around a rotational axis. The cylindrical ring structure comprise a plurality of ring-shaped permanent magnet packages arranged coaxially around the rotational axis, the plurality of permanent magnet packages being adapted to form at least one coolant passage through the cylindrical ring structure. The cylindrical ring structure is adapted to serve as a sump for coolant, such that the sump is defined, at least in part, by the radially inner surface of the cylindrical ring structure, and further comprises at least one coolant passage inlet that extends from the radially inner surface of the cylindrical ring structure to the at least one coolant passage and wherein at least one coolant passage outlet is arranged at one axial end of the cylindrical ring structure.

### FIELD OF THE INVENTION

The invention relates to a generator for use in a power system of a wind turbine.

### BACKGROUND OF THE INVENTION

Wind turbines convert kinetic energy from the wind into electrical energy, using a large rotor with a number of rotor blades. A typical Horizontal Axis Wind Turbine (HAWT) comprises a tower, a nacelle on top of the tower, a rotor hub mounted to the nacelle and a plurality of wind turbine rotor blades coupled to the rotor hub. Depending on the direction of the wind, the nacelle and rotor blades are turned and directed into an optimal direction by a yaw system for rotating the nacelle and a pitch system for rotating the blades.

The nacelle houses many functional components of the wind turbine, including for example a generator, gearbox, drive train and rotor brake assembly, as well as convertor equipment for converting the mechanical energy at the rotor into electrical energy for provision to the grid. The gearbox steps up the rotational speed of the low speed main shaft and drives a gearbox output shaft. The gearbox output shaft in turn drives the generator, which converts the rotation of the gearbox output shaft into electricity. The electricity generated by the generator may then be converted as required before being supplied to an appropriate consumer, for example an electrical grid distribution system. So-called “direct drive” wind turbines that do not use gearboxes are also known. In a direct drive wind turbine, the generator is directly driven by a shaft connected to the rotor.

In a known scheme, the generator of a wind turbine is an IPM (interior permanent magnet) electric machine composed of an external stator assembly which surrounds an internal rotor assembly. The IPM internal rotor assembly is typically composed of multiple annular permanent magnetic packages, supported on a central shaft. The gearbox output shaft interfaces with the central shaft of the rotor assembly.

Like in other electric machines, the permanent magnetic packages are typically made of a stack of ring-shaped metal layers with aligned holes for receiving the permanent magnets that create the required magnetic field.

A technical consideration for the design of IPM-type generators is that the generator becomes less effective as it heats up during use. IPM-type generators are particularly sensitive to raised temperatures as it adversely effects the magnetic field produced by the internal magnets thereby reducing the power capability of the generator. In extreme cases, uncontrolled overheating can result in irreversible demagnetization. Moreover, since the material for the magnets is expensive, it is desirable to maintain generally low temperature conditions in the magnets to reduce the amount of magnet material is required. It will be appreciated, therefore, that wind turbine performance and lifetime is therefore reliant upon efficient cooling of the IPM-type generators.

Air-cooling is a cost-effective method of providing cooling of the generator. However, a megawatt-scale generator may produce too much thermal energy for currently air-cooling methods to cool the generator effectively, and this applies particularly to IPM-type generators. The lack of efficient cooling of the generator can result in a temperature rise in and around the generator components which is undesirable.

It is against this background that the examples of the invention have been devised.

### SUMMARY OF THE INVENTION

According to a first aspect of the invention, there is provided a generator rotor for a wind turbine, comprising a cylindrical ring structure defining a radially inner surface and a central hollow portion, and being arranged to rotate around a rotational axis. The cylindrical ring structure comprises a plurality of permanent magnet packages arranged coaxially around the rotational axis, and being adapted to form at least one coolant passage through the cylindrical ring structure. The cylindrical ring structure is adapted to serve as a sump for coolant, such that the sump is defined, at least in part, by the radially inner surface of the cylindrical ring structure, and further comprises at least one coolant passage inlet that extends from the radially inner surface of the cylindrical ring structure to the at least one coolant passage and wherein at least one coolant passage outlet is arranged at one axial end of the cylindrical ring structure.

One benefit of the rotor of the examples of the invention is that the coolant passage is provided internally to the stacked layers of the permanent magnet packages of the cylindrical ring structure. This arrangement is therefore effective at providing heat exchange between the magnetically active sections of the cylindrical ring structure, which heat up during use, and the coolant flowing within it. Moreover, the passage outlet provided at one end of the cylindrical ring structure provides a means to discharge coolant towards other components of the generator which may require cooling, for example the stator windings that are located radially outwards of the rotor.

According to another aspect, there is provided a generator rotor for a wind turbine, comprising a cylindrical ring structure defining a radially inner surface and a central hollow portion, and being arranged to rotate around a rotational axis (X). The cylindrical ring structure comprises a plurality of permanent magnet packages arranged coaxially around the rotational axis. The cylindrical ring structure is adapted to serve as a sump for coolant, and wherein the radially inner surface of the cylindrical ring structure is adapted to define a plurality of ridges which serve to accelerate coolant in the sump during rotation of the cylindrical ring structure, in use.

Beneficially the structure of the ridged radially inner surface increases the surface area of the permanent magnet packages that is exposed to coolant in the rotating sump which improves the cooling effect. Furthermore, the ridges act to accelerate coolant quickly up to the rotational speed of the rotor, in use, thereby suppressing turbulence in the coolant contained in the rotating sump which reduces the amount of coolant mist or spray that is generated by the rotation of the rotor.

Further optional and advantageous features are provided in the dependent claims.

In another aspect, the examples of the invention provide a generator for a wind turbine, the generator including a stator including stator windings at a radially outer position and a generator rotor as defined above adapted to be rotatable with a volume radially inward of the stator windings.

In yet another aspect, the examples of the invention provide a wind turbine comprising a generator as described above.

### BRIEF DESCRIPTION OF THE DRAWINGS

The present invention will now be described, by way of example only, with reference to the attached drawings, in which:

FIG. 1 is a front view schematic diagram showing a typical wind turbine;

FIG. 2 is a schematic and perspective view of the main functional components housed within a nacelle of a typical wind turbine;

FIG. 3 is an isometric view of the generator of the nacelle of FIG. 2, coupled to a gearbox;

FIG. 4 is a cutaway view of the generator of FIG. 3, including a generator rotor;

FIG. 5 is a drive end perspective view of a generator rotor that may be used in the generator of FIGS. 3 and 4;

FIG. 6 is a schematic view of the generator illustrating a partial view of the rotor of FIG. 5;

FIGS. 7 to 11 are various views of feature and parts of the rotor showing further detail of passages for cooling fluid within the rotor;

FIG. 12 is a schematic view illustrating a profile of radially inner surface of the rotor of FIGS. 5 to 11;

FIG. 13 is a schematic view of another example of a rotor that may be used in the generator of FIGS. 3 and 4;

FIGS. 14 and 15 are schematic views, taken along the rotational axis of the rotor, that show the principle of different internal profiles of the rotor.

### DETAILED DESCRIPTION

A specific embodiment of the present invention will now be described in which numerous features will be discussed in detail in order to provide a thorough understanding of the inventive concept as defined in the claims. However, it will be apparent to the skilled person that the invention may be put in to effect without the specific details and that in some instances, well known methods, techniques and structures have not been described in detail in order not to obscure the invention unnecessarily.

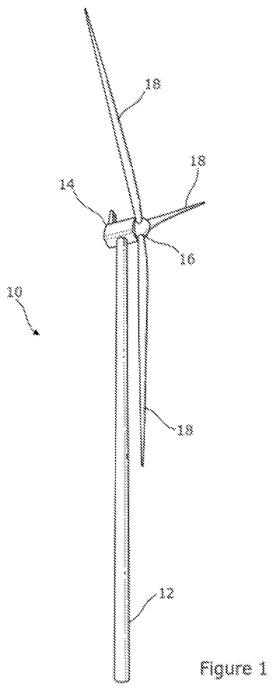

In order to place the embodiments of the invention in a suitable context, reference will firstly be made to FIG. 1, which illustrates a typical Horizontal Axis Wind Turbine (HAWT) in which a generator rotor assembly according to an embodiment of the invention may be implemented. Although this particular image depicts an on-shore wind turbine, it will be understood that equivalent features will also be found on off-shore wind turbines. In addition, although the wind turbines are referred to as ‘horizontal axis’, it will be appreciated by the skilled person that for practical purposes, the axis is usually slightly inclined to prevent contact between the rotor blades and the wind turbine tower in the event of strong winds.

The wind turbine 1 comprises a tower 2, a nacelle 4 rotatably coupled to the top of the tower 2 by a yaw system, a rotor hub 8 mounted to the nacelle 4 and a plurality of wind turbine rotor blades 10 coupled to the rotor hub 8. The nacelle 4 and rotor blades 10 are turned and directed into the wind direction by the yaw system.

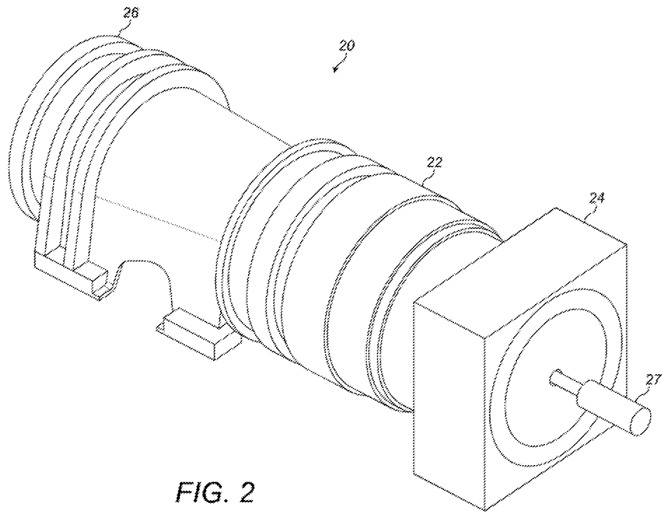

The nacelle 4 houses many functional components of the wind turbine, including the generator, gearbox, drive train and rotor brake assembly, as well as convertor equipment for converting the mechanical energy of the wind into electrical energy for provision to the grid. With reference to FIG. 2, the nacelle 4 may include a shaft housing 20, a gearbox 22 and a generator 24. A main shaft 26 extends through the shaft housing 20, and is supported on bearings (not shown). The main shaft 26 is connected to, and driven by, the rotor 8 and provides input drive to the gearbox 22. The gearbox 22 steps up the rotational speed of the low speed main shaft via internal gears (not shown) and drives a gearbox output shaft. The gearbox output shaft in turn drives the generator 24, which converts the rotation of the gearbox output shaft into electricity. The electricity generated by the generator 24 may then be converted by other components (not shown) as required before being supplied to an appropriate consumer, for example an electrical grid distribution system. So-called “direct drive” wind turbines that do not use gearboxes are also known. The gearbox may therefore be considered optional.

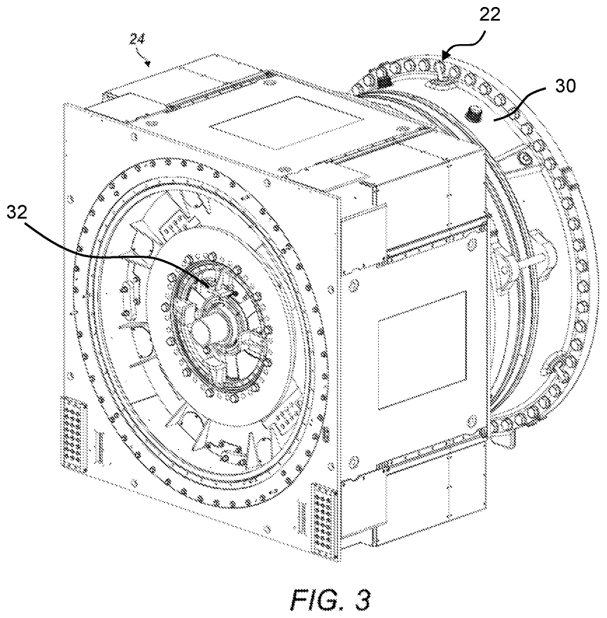

The gearbox 22 and generator 24 may be coupled together in an integrated unit. FIG. 3 shows the generator 24 in more detail. In FIG. 3, also the housing of the last stage of the gearbox 22 is shown as it is coupled to the housing of the generator 24.

With reference firstly to the gearbox 22, a gearbox housing 30 is generally cylindrical. The cylindrical configuration of the gearbox housing is due to the specific type of gearbox that is used in the illustrated embodiment, which is an epicyclic gearbox. As the skilled person would know, an epicyclic gearbox comprises a series of planet gears that are arranged about a central sun gear, and which collectively are arranged within an encircling ring gear. The ratio of the number of teeth between the ring gear, the planet gear and the sun gears determines the gear ratio of the gearbox. For clarity, fine detail of the gearbox will not be described in further detail here as the gearbox is not the principal subject of the invention. Suffice to say that other gearbox configuration could also be used, although it is currently envisaged that an epicyclic gearbox provides an elegant solution fit for the confines of a wind turbine nacelle.

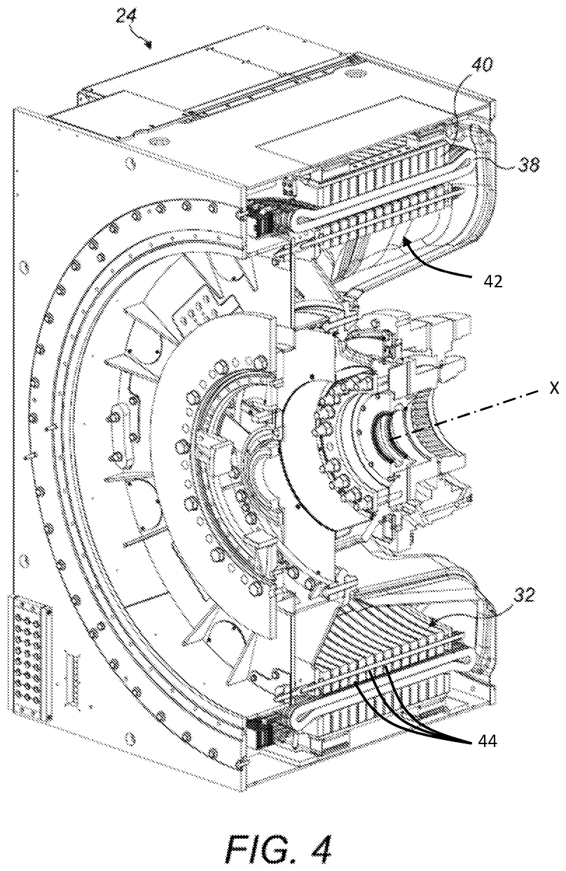

The output shaft of the gearbox 22 interfaces with a rotor 32 of the generator 24. As such, the major axis of the gearbox output shaft defines the rotational axis of the generator 24. In FIG. 4, a cutaway view of the generator 24 is provided, isolated from the gearbox. The generator 24 in the illustrated embodiment is an IPM (interior permanent magnet) electric machine having an external stator, which surrounds the rotor 32. The stator includes stator windings 38 a stator core 40. It is however noted that the invention is not limited to a specific type of stator.

In FIG. 4, the generator rotor 32 can be seen radially inwards of the stator windings 38. The rotor 32 is supported so that it can rotate within the windings in the conventional way. Although not seen in FIG. 4, it should be appreciated that a suitable bearing arrangement may be provided that supports the rotor 32 stably within the stator windings 38 so that it is able to rotate.

The rotor 32 has a non-drive end, whereby the non-drive end faces away from the wind turbine drivetrain when the wind turbine is in use, and a drive end which faces toward the drivetrain when the wind turbine is in use. The non-drive end view of the rotor 32 can be seen on the left hand side of FIGS. 3 and 4, and the drive end view of the rotor 32 can be seen on the right hand side.

The rotor 32 is made up of a cylindrical ring structure 42 defining a central hollow portion or region and arranged to rotate around a rotational axis X. The cylindrical ring structure 42 comprises a plurality of permanent magnet packages 44, three of which are labelled in FIG. 4. Whereas FIG. 4 illustrates a general configuration of a rotor 32 having a cylindrical ring structure that is defined by a plurality of ring-shaped permanent magnet packages 44, the discussion will now turn to the remaining Figures that show another example of a rotor 50 that is apt to be used in the generator 26 shown in the previous Figures. The previous Figures therefore provide the rotor 50 now described with suitable context. It will also be noted that the general cylindrical hub-less structure of the rotor 50 is the same as the rotor 32 in FIG. 4, so the following discussion will focus on the differences.

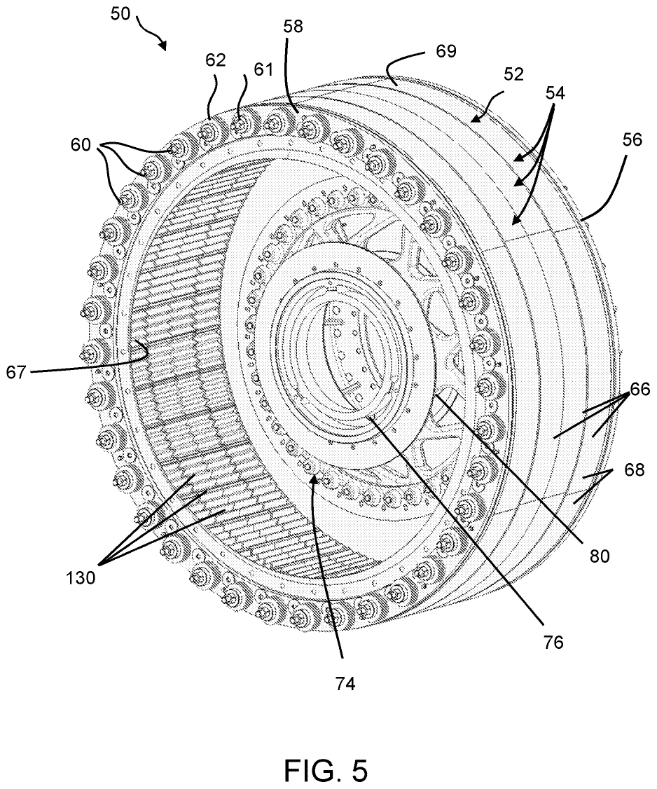

As will be appreciated in FIG. 5, the illustrated rotor 50 has a generally cylindrical ring-shaped structure 52 that is defined by a plurality of ring-shaped permanent magnet packages 54 (three of which are labelled in FIG. 5) provided therebetween two ring end rings or plates. The two end plates comprise a first end plate 56 and a second end plate 58 arranged at opposite ends of the cylindrical ring structure 52. The first end plate 56 is located at the non-drive end of the cylindrical ring structure 52, and the second end plate 58 is located at the drive end of the cylindrical ring structure 52.

The permanent magnet packages 54 are held together to form the cylindrical ring structure 52 by a plurality of tie rods 60 (three labelled in FIG. 5). The tie rods 60 are arranged circumferentially about the cylindrical ring structure 52 and equi-angularly spaced, in this example. Each of the tie rods 60 carries suitable tensioning nuts 61 and a set of shims or washers 62 which are adapted for selectively applying a compressive force to the permanent magnet packages 54 when the cylindrical ring structure 52 is assembled.

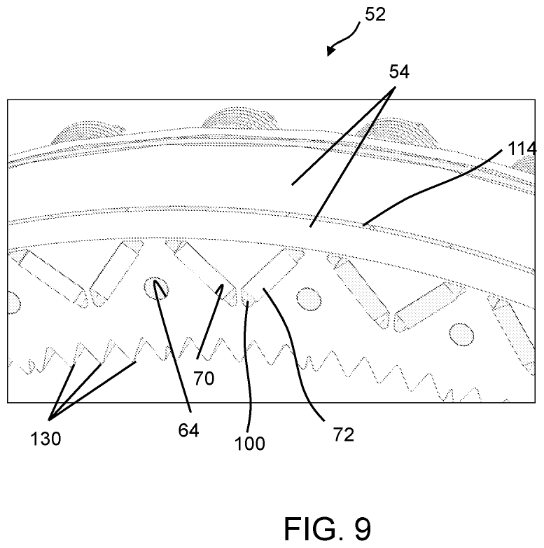

The tie rods 60 are accommodated in a respective set of tie rod holes 64 which extend axially through the permanent magnet packages 54. The tie rod holes 64 are located around the body of each of the permanent magnet packages 54, and are mutually arranged so that the tie rod holes 64 of adjacent permanent magnet packages 54 are complementary in size and position so that they align to form respective bores through which the tie rods 60 are received. The tie rod holes 64 can be observed in FIG. 9.

The permanent magnet packages 54 in this example comprise a plurality of coaxially stacked ring-shaped segmented layers 66, each comprising a plurality of contiguous segment sheets 68 arranged around the rotational axis to form the ring-shaped segmented layer 66. The segmented form of the ring-shaped segmented layers 66 provide various advantages in terms of structural robustness of the cylindrical ring structure 52, but it should be noted that the ring-shaped segmented layers 66 need not be segmented and instead the permanent magnet packages 54 may be formed from ring-shaped layers that are formed of a single piece. Note, also, although the segmented layers 66 and sheets 68 are not structurally shown in FIG. 5, for clarity, the skilled person would understand that such a laminated structure is useful in magnetically active bodies. However, in principle the ring-shaped permanent magnet packages 54 may be formed each from a single piece of material without such a laminated/layered structure. The stacked ring configuration of the cylindrical ring structure 52 comprises a radially inner surface 67 and a radially outer surface 69.

Each of the permanent magnet packages 54 includes a plurality of magnet pockets 70 shaped suitably to accommodate respective permanent magnets 72. The magnet pockets 70 and the permanent magnets 72 are best observed in FIG. 9. As can be seen the permanent magnets 72 are grouped into pole pairs in order to generate an appropriate magnetic field, as would be understood by the skilled person. The precise formation, number and order of the permanent magnets 72 in the illustrated examples is not crucial so does not form part of the invention, although they are described here for context.

It will be noted from the above discussion and from the Figures that the rotor 50 does not comprise a central shaft extending axially through the centre of the cylindrical ring structure 52. Instead, the rotor 50 of the illustrated example of the invention has a drive hub 74 that is connected to and so supports the cylindrical ring structure 52 from only one of its ends. The arrangements means that a large open volume is defined inside the cylindrical ring structure 52. As shown, the drive hub 74 is connected to the first end plate 56 of the cylindrical ring structure 52.

The drive hub 74 includes a central annular drive connector or flange 76 that serves for connection to an output drive shaft of the gearbox (not shown). The drive connector 76 is coupled to or is integral with the first end plate 56 through a radial supporting structure in the form of a web-like radial plate 80. The precise form of the radial supporting structure 80 is not crucial. However, its function is to support the drive connector 76 to the first end plate 56. As such the radial supporting structure 80 may be substantially solid, or may comprise a plurality of radial spokes which define a series of apertures, as is shown here, which may be beneficial for mass reduction.

The circumference of the drive connector 76 is smaller than the circumference of the first end plate 56. The drive connector 76 comprises a ring-shaped element that is adapted to connector to a drive shaft input from a gearbox (not shown). In addition, the drive connector 76 is located within the central hollow portion defined by the cylindrical ring structure 52.

It should be noted that this so-called ‘hubless’ design of rotor allows a large generator rotor structure to be produced without needing to assemble permanent magnet packages onto a central core or shaft, which can achieve a cost reduction and reduced mass.

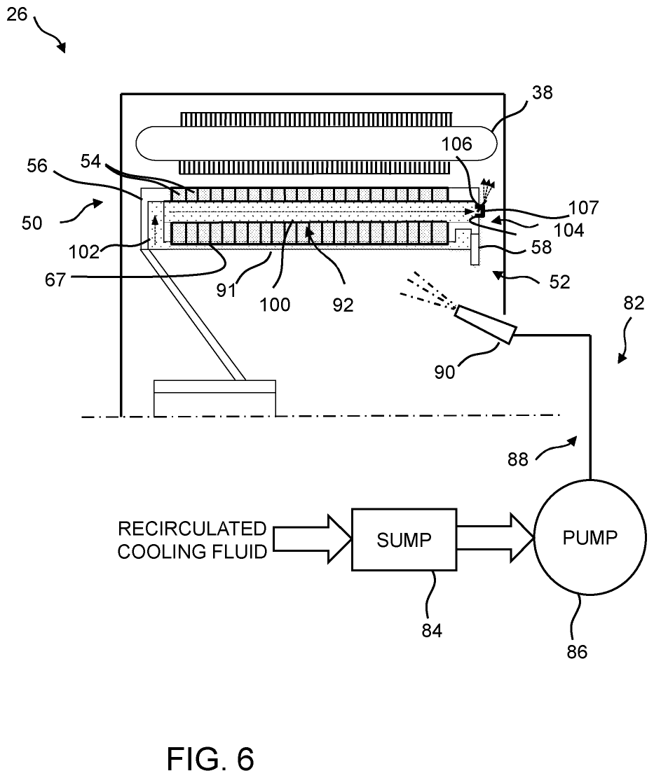

With reference also to the schematic view of FIG. 6, it should be appreciated that the rotor 50 and particularly the cylindrical ring structure 52 forms part of a coolant system 82 that is adapted to provide a flow of liquid coolant to the rotor 50. The coolant may be any suitable liquid such as a type of oil or other non-oil based coolant.

In overview, the coolant system 82 comprises a sump 84, a pump 86, a cooling circuit 88, one or more fluid delivery nozzles 90 and one or more fluid passages 92 defined through the cylindrical ring structure 52.

It should be noted at this point that the in the schematic form as shown in FIG. 6, the coolant system 82 is necessarily simplified for the sake of clarity. As such, various component of the cooling system 82 may be more complex than as illustrated.

The sump 84 is configured to receive cooling fluid that is recirculated through the cooling system 82. The sump 84 may be formed in different ways, for example in a lower portion of the housing of the generator 26 or in a separate tank or reservoir separate therefrom. The function of the sump 84, however, is to collect and store the coolant as it is returned from the cooling circuit 88 and the fluid passages 92 in the cylindrical ring structure 52.

The sump 84 is connected to and therefore feeds coolant to the pump 86. The pump 86 may be of any suitable form and generates sufficient pressure in the cooling circuit 88 to generate a spray of coolant from the one or more coolant delivery nozzles 90.

At least the one or more coolant delivery nozzles 90 are in a stationary frame of reference with respect to the rotating frame of reference of the cylindrical ring structure. The sump 84, pump 86 and cooling circuit 88 may also be located in the same stationary reference frame.

The one or more coolant delivery nozzles 90 are adapted to direct coolant to the radially inner surface 67 of the cylindrical ring structure 52. The shape of the cylindrical ring structure 52 is adapted such that the radially inner surface 67 defines, at least in part, a rotating sump 91 or collector reservoir for coolant. The first and second end plates 56,58 are provided with suitable wall portions to act as side walls of the rotating sump to retain coolant against the radially inner surface 67 of the cylindrical ring structure 52 as the rotor 50 rotates. However, it should be noted that other adaptations are possible to retain coolant within the rotating sump. Note that in FIG. 6 the presence of coolant is depicted by the dotted area.

As can be seen schematically in FIG. 6, the cylindrical ring structure 52 is adapted to define one of more fluid passages 92 through it so as to provide a cooling effect for the permanent magnet package 54. The one or more fluid passages 92 includes at least one axial passage 100 that extends generally in an axial direction through the cylindrical ring structure 52 and therefore traverses the adjacent permanent magnet packages 54.

It should be noted at this point that the at least one axial passage 100 is shown as a straight section of passage or channel in the schematic view of FIG. 6. However, in practice the axial passage 100 may be created by various channel structures through the permanent magnet packages 54, as will be discussed later.

The at least one axial passage 100 includes a passage inlet 102 and a passage outlet 104.

The passage inlet 102 extends from the radially inner surface 57 of the cylindrical ring structure 52 and therefore provides a route for coolant fluid to access the at least one axial passage 100 from the rotating sump. The passage inlet 102 serves to collect coolant and therefore forms part of the rotating sump 91.

As can be seen in FIG. 6, the passage inlet 102 is defined by the first end plate 56 in this example. However, the passage inlet 102 may be provided by other components of the cylindrical ring structure 52, for example by one or more of the permanent magnet packages 54 and/or by a spacer plates (not shown) provided between a pair of permanent magnet packages 54. The passage inlet 102 may be annular in form so as to connect to multiple ones of axial passages 100.

The passage outlet 104 associated with the axial passage 100 is adapted to cause a spray of coolant external to the cylindrical ring structure 52. Due to the rotation of the rotor, coolant exiting the passage outlet 104 is flung radially outwards towards the windings of the generator. The passage outlet 104 can further be adapted to direct a spray of coolant in the direction of the windings.

In the illustrated example, the passage outlet 104 provides a restricted orifice 106, the cross sectional flow area of which is smaller than the cross sectional flow area of the respective axial passage 100. In this example, the passage outlet 104 is provided by a nozzle component 107 that is suitably received into the second ring plate 58 of the cylindrical ring structure 52. For example, the nozzle component 107 may be screw-threaded into the second ring plate 58.

The nozzle component 107 provides the passage outlet 104 with a restricted orifice, the purpose of which is to generate a spray of coolant from the outlet 104. Due to the rotation of the cylindrical ring structure 52, in use, such a coolant spray will be directed radially outwards towards the stator windings 38. However, the nozzle component 107 may also be adapted to direct the spray radially outwards due to the orientation of the restricted orifice 106.

More specifically, the flow area of the restricted orifice 106 is envisaged to be less than 20% of the respective average flow area of the axial passage 100. For example, the flow area of the restricted orifice 106 may be less than 15%, or less than 10% or less than 5% of the respective flow area of the axial passage 10 which feeds coolant to the passage outlet 104.

In this discussion, references to ‘flow area’ can be considered to be the cross section area of the relevant flow passage perpendicular to the direction of flow. Also, it should be noted that the flow area of the passage outlets associated with different ones of the axial passages 100 may be different cross sectional areas. In the event that the cross section of a passage is not constant along its length, the flow area of that passage is considered to be the average cross section along the length of the passage.

The restricted flow area of the passage outlet 104 compared to the flow area of the axial passage 100 provides a balance between permitting coolant to be sprayed out of the nozzle 90 and allowing a sufficient volume of cooling fluid to be accumulated in the rotating sump.

In FIG. 6, it will be appreciated that a single axial passage 100 is shown, having a respective passage inlet 104 and a respective passage outlet 106. However, the rotor includes a plurality of such axial passages 100 that are distributed circumferentially around the cylindrical ring structure 52. Such plurality of axial passages 100 may be fed coolant by a single passage inlet 102 that is annular in form. However, it is also possible that each axial passage 10 has a respective passage inlet 102.

It should be also noted that whereas the axial passage 100 shown in FIG. 6 has coolant flowing through it from left to right in the orientation of the drawings, other ones of the axial passages 100 defined in the cylindrical ring structure 52 may be adapted so that coolant flows them through the opposite direction. In such a configuration of cylindrical ring structure 52, it should be noted that the second ring plate 58 will therefore define a further one or more passage inlets to fee those respective axial passages.

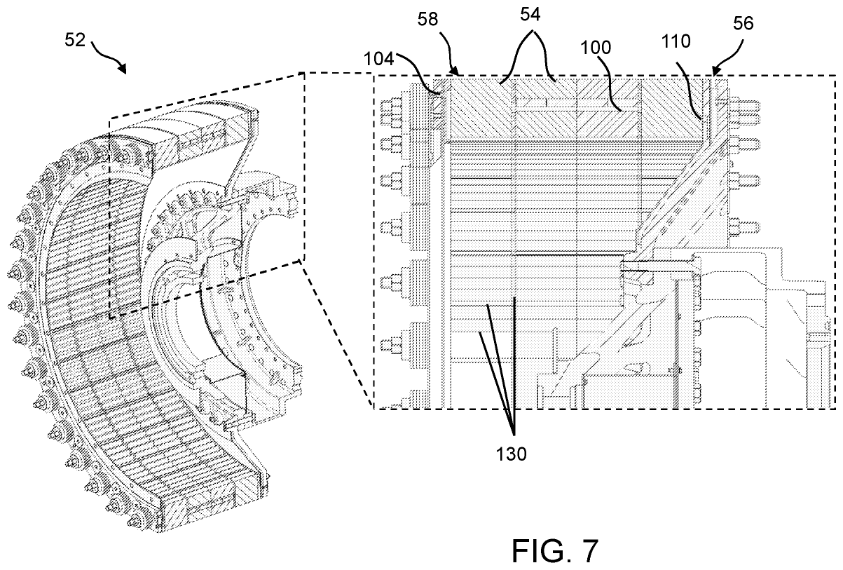

With the context of the schematic view of the cylindrical ring structure 52 shown in FIG. 6, FIGS. 7, 8, 9 and 10, show further internal detail of the cylindrical ring structure 52, and particularly further detail of the coolant passages defined therein.

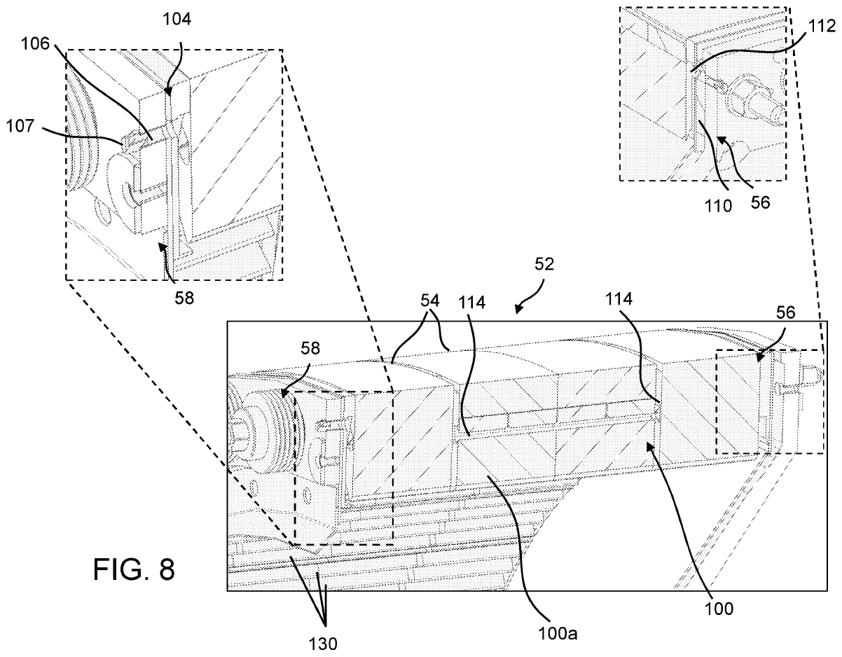

FIG. 7 shows a section through the cylindrical ring structure 52 in which the inset panel emphasises an enlarged view of part of the cross section, whereas FIG. 8 shows the enlarged view of FIG. 7 in further detail. As can be seen in these figures the first end plate 56 is shaped to define radial recesses 110 that constitute the passage inlets 102 as shown in FIG. 6. A plurality of such radial recesses 110 are provided circumferentially about the first end plate 56. Each one of the radial recesses 110 are provided with one or more ports 112 (best seen in FIG. 8) which serve as entry points to the axial passages 100 provided through the permanent magnet packages 54.

Suitable adaptations may be made to the end plate 56 such that it can recirculate coolant flow from one of the axial passages 100 in the cylindrical ring structure 52 to another one of the axial passages 100. In this sense, therefore, the first end plate 56 may be adapted to function as a coolant flow control manifold having a suitable manifold volume that is adapted to direct coolant between cooling passages.

Similarly, the second end plate 58 may also serve the purpose of a coolant flow control manifold. As shown clearly in FIG. 8, the second end plate 58 is shown as having suitable internal channels that define the passage outlet 104, as being closed off by the nozzle component 107 having a restricted orifice 106. A plurality of such passage outlets 104 are provided circumferentially about the second end plate 58, although only one is shown in FIG. 8. Usefully, the nozzle component 107 can be removed and replaced with a different nozzle component, as required, which enables the size and configuration of the restricted orifice 106 to be adjusted.

A part of the axial passage 100 that extends between the passage inlet 102 and the passage outlet 104 is shown in FIG. 8. It should be noted that the axial passage 100 does not necessarily follow a straight path through the permanent magnet packages 54. Here, a central portion 100a of the axial passage 100 is defined through a set of six centrally positioned magnet packages 54. Spacer plates 114 provide a means to divert or control the flow direction of the coolant through the magnet packages 54 into other parts of the axial passage defined by other ones of the magnet packages 54.

FIG. 9 illustrates how the axial passages 100 through the magnet packages 54 may be defined. Here, it will be appreciated that the permanent magnets 72 are received in respective magnet pockets 70. Those magnetic pockets 70 are shaped to be larger than the permanent magnets 72 so as to define gaps at least at one of the permanent magnets 72. Those gaps provide part of the axial passage 100 through which coolant is able to flow. In this way, the coolant contacts both the material of the ring-shaped permanent magnet package 54 but also the magnets 72 themselves, benefiting the cooling function.

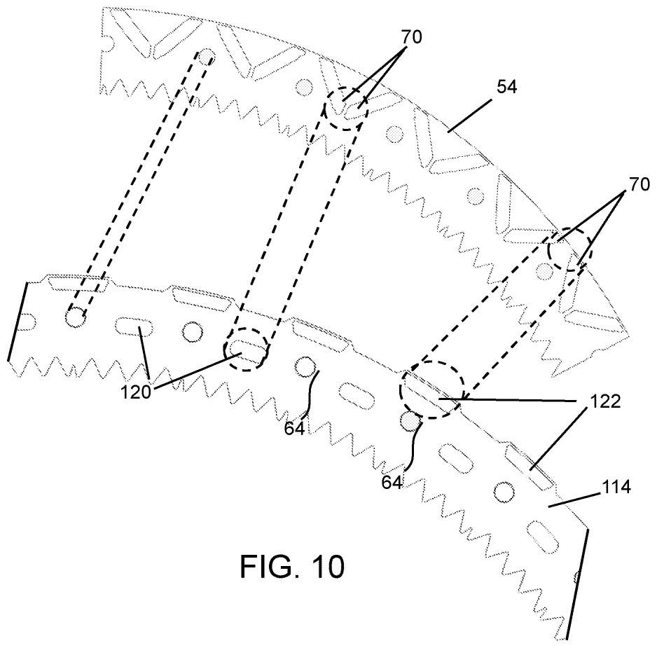

Referring also to FIG. 10, there is shown a spacer plate 114 which may fit between selected ones of the permanent magnet packages 54, one of which is shown next to the spacer plate 114 for comparative purposes.

The spacer plate 114 is shown as defining various apertures, include tie rod holes 64. However, the spacer plate 114 further defines a set of first transition apertures 120 and a set of second transition apertures 122.

The first transition apertures 120, when the spacer plate 114 is located within the cylindrical ring structure 52, are aligned with a respective pair or magnetic pockets 70. More specifically, the first translation apertures 120 overlap radially inner ends of the magnetic pockets 70. Therefore, the first transition apertures 120 bridge the gap between adjacent magnet packages 54 and serve to control the flow of coolant through the axial passages 100. It will be appreciated that the shape and configuration of the first transition apertures 120 may be changed to change the direction of coolant flow.

The second transition apertures 122, when the spacer plate 114 is located within the cylindrical ring structure 52, are aligned with another respective pair of magnet pockets 70, and, more specifically, radially outer ends of the magnet pockets 70.

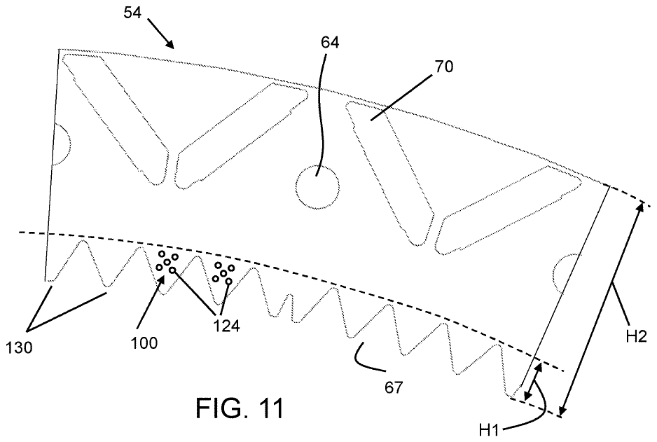

In the context of the invention, it is not essential for the axial passages 100 to be defined by the magnet pockets 70 of the permanent magnet packages 54. FIG. 11 shows a further option in this regard. Here, it can be seen that the axial passages 100 are formed by a plurality of smaller passages or sub-passages 124. The sub-passages 124 are in addition to the tie rod holes 64 and the magnet pockets 70. The sub-passages 124 may be defined as necessary in adjacent ones of the permanent magnet packages 54 and any present spacer plates 114 to provide contiguous axial passages 100 through the cylindrical ring structure 52. The sub-passages 124 may be in the form of drillings.

In the illustrated example, the sub-passages 124 are located proximal to the radially inner surface 67 of the permanent agent package 54. In one example, the sub-passages 124 are confined to a radially inner margin ‘H1’ of the permanent magnet packages 54, as shown in FIG. 11. Preferably the radial dimension of the radial inner margin H1 is less than 20% of the radial dimension H2 of the permanent magnet packages 54. For example, the inner margin H1 within which the sub-passages 124 are defined may be less than 18% or less than 15% or less than 10% of the radial height H2 of the permanent magnet packages 54.

It is believed that this may provide cooling benefits and, moreover, the sub-passages 124 are located away from the magnetic pockets 70 and the magnets 72 and so do not interfere with the flow of magnetic flux through the permanent magnet packages 54.

It will be appreciated from the above discussion that the cylindrical ring structure 52 features numerous adaptations to facilitate the flow of coolant through it, and to eject a spray of coolant from it, in order to achieve certain cooling benefits for the rotor 50 during operation. In particular, the cylindrical ring structure 52 is adapted to capture and retain coolant against the radially inner surface 67 thereby creating a rotating sump that generates a centrifugal pressure of coolant within the sump which drives the coolant through the passages 100, 102, 104 defined in the cylindrical ring structure 52.

A further feature of the cylindrical ring structure 52 will now be discussed with reference to the drawings that have been a part of the discussion so far. As can be seen in FIG. 5, and FIGS. 6 to 11, the cylindrical ring structure 52 is configured such that the radially inner surface 67 has an undulating profile. That is, the radially inner surface 67 defines a an array of ridges or ribs 130 that extend in the axial direction, from the first end plate 56 to the second end plate 58. The ridges 130 are therefore aligned with, and therefore are parallel to, the direction of the rotational axis, in this example. In other examples the ridges 130 may extend obliquely to the rotational axis. In such an example, the ridges would form a helical arrangement.

Beneficially the structure of the ridged radially inner surface 67 increases the surface area of the permanent magnet packages 54 that is exposed to coolant in the rotating sump 91 which therefore improves the cooling effect. Furthermore, the ridges 130 act to accelerate coolant quickly up to the rotational speed of the rotor 50, in use, thereby suppressing turbulence in the coolant contained in the rotating sump 91 which reduces the amount of coolant mist or spray that is generated by the rotation of the rotor 50. This is particularly the case if the level of the coolant in the sump is maintained at a level that is below the radial peaks of the ridges 130. By this action, the array of ridges 130 help to accelerate coolant in the rotational sump 91 up to speed quickly after it is delivered by the coolant nozzles 90 and so guards against excessing ‘sloshing’ of the coolant in the rotational sump 91. Furthermore, the presence of the troughs between the ridges provides more stability to the thickness and distribution of oil film on the radially inner surface 67.

In the illustrated example, the array of ridges 130 extend about the entire circumference of the radially inner surface 67. However, in some other examples of the invention this is not the case and there may be one or more arrays of ridges 130 that extend around a part of the circumference of the radially inner surface 67.

In the illustrated example the ridges 130 form a smooth undulating surface when seen in cross section. The benefit of this is that the peaks of the ridges 130 are curved and therefore less likely to form concentrated stress points.

The radial height of the ridges 130 may be selected as appropriate. However, in the illustrated embodiment, the radial height of the ridges is less than approximately 20% of the radial height of the permanent magnetic packages 54. This can be appreciated particularly in FIG. 11, where the radial height of the permanent magnet packages 54 is denoted by H2 and the ridges 130, and the radial height of the ridges 130 is denoted by H1. Notably, the ridges 130 can serve to define the radial margin H1 within which the sub-passages 124 are contained.

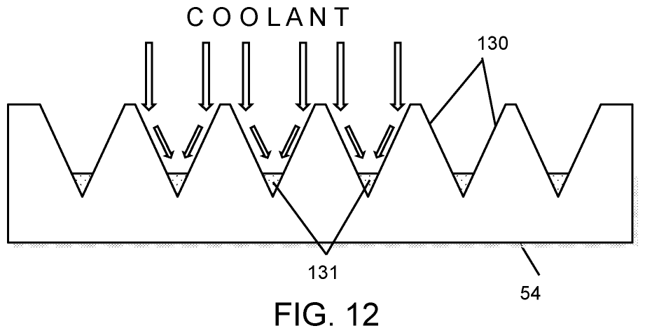

The functionality of the array of ridges 130 can be appreciated by viewing FIG. 12. Here, FIG. 12 illustrates schematically a section of ridges 130. It will be noted that the ridges 130 in this example have a more sharply defined sawtooth profile compared to the more smoothly undulating formation as described with reference to the previous Figures. One benefit of this is that a higher number of ridges can be included in the same circumferential length and the ridges can be made deeper which therefore has a greater effect in the suppression of coolant mist during operation.

As will be appreciated by the arrows marked ‘coolant’, the coolant that is delivered by the coolant nozzles 90 impacts the slanted side walls of the ridges 130 and then runs down into the troughs 131 of the ridges 130. This avoids the coolant being incident on a flat surface, and/or coolant already present in the troughs, which lessens the amount of generated coolant mist.

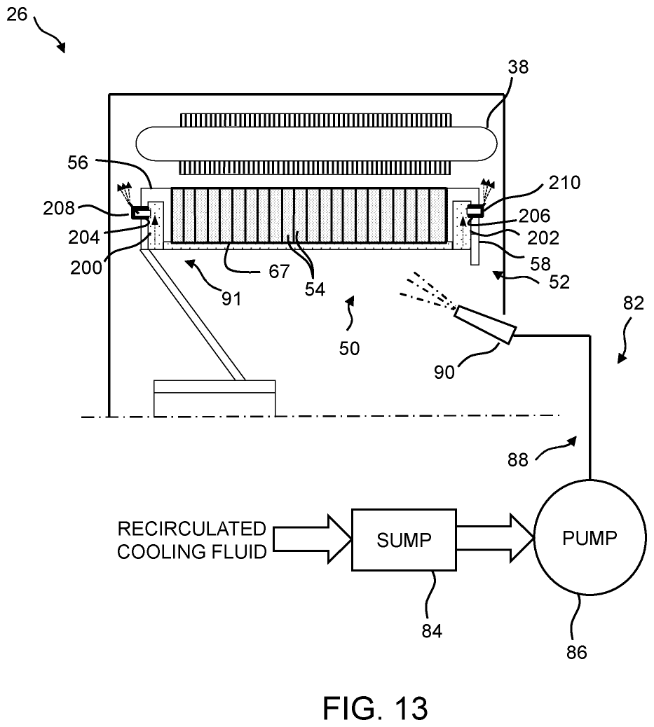

It should be noted at this point that the feature of the array of ridges 130 may be used in the cylindrical ring structure 52 without the structure 52 also featuring axial coolant passages 100 extending through the cylindrical ring structure. FIGS. 13, 14 and 15 provide an example of such a configuration of rotor 50.

Referring firstly to FIG. 13, it will be noted that the schematic view of the generator 26 in this Figure shares many similarities to that show in FIG. 6. Therefore, this discussion will focus on the differences between the two illustrated examples and the same reference numerals will be used to refer to the same or similar parts and features.

In the example shown in FIG. 13, it will be appreciated that the rotor 50 is not provided with axial passages as in the rotor 50 of FIG. 6. However, the cylindrical ring structure 52 is once again adapted to retain coolant against its radially internal surface 67 and to urge the coolant towards the axial ends, thereby forming a rotating sump 91.

The radial sump 91 is also formed by at least one radial passage which, in this example, comprise a first radial passage 200 and a second radial passage 202. The first radial passage is provided by the first end plate 56 and the second radial passage 202 is defined by the second end plate 58.

The first radial passage 200 is provided with at least one first outlet 204 and the second radial passage 202 is also provides with at least one second outlet 206. In this example, the at least one first outlet 204 is formed by a respective nozzle 208 connected to the first end plate 56, and the at least one second outlet 206 is also formed by a respective nozzle 210 received in the second end plate 58.

It should be appreciated that the first radial passage 200 and the second radial passage 22 may be annular in form and so each of the passages may feed a plurality of respective outlets 204,206 distributed circumferentially about the first and second end plates 56,58.

As in the previous illustrated example, each of the first outlets 204 and the second outlets 206 provides a restricted orifice, the purpose of which is to generate a spray of coolant from the outlets 204,206. Due to the rotation of the cylindrical ring structure 52, in use, such a coolant spray will be directed radially outwards towards the stator windings 38. However, each of the nozzles 208,210 may also be adapted to direct the spray radially outwards due to the orientation of the restricted orifice.

Although not shown specifically in FIG. 13, it should be appreciated that the radially inner surface 67 of the cylindrical ring structure 52 is adapted to comprise an array of ridges as described above with respect to the previous example and convey the same technical advantages.

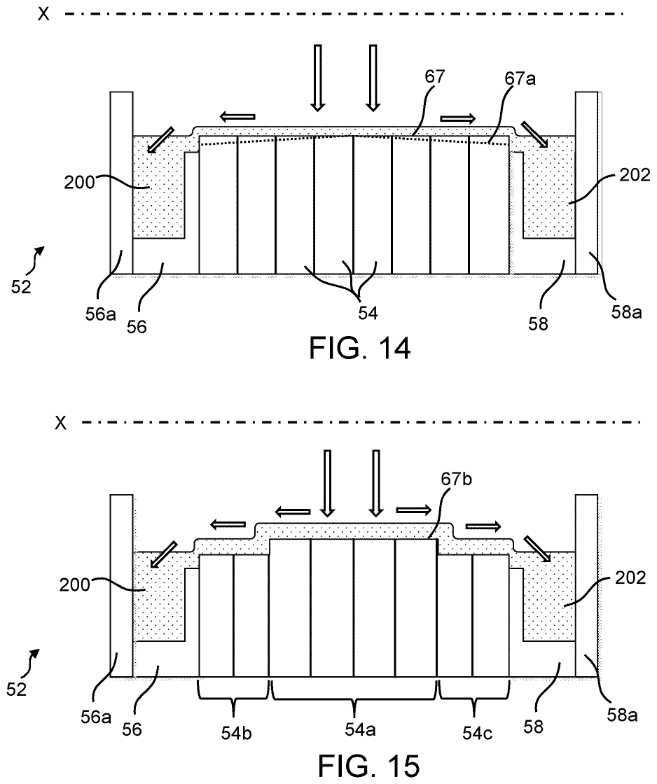

FIG. 14 illustrates schematically how the coolant is distributed across the radially inner surface 67 of the cylindrical ring structure 52 in use. As can be seen, the first and second end plates 56,58 provide walls 56a,58a that acts as coolant containment barriers.

As shown by the arrows, the coolant is directed towards the radially inner surface 67 and is then urged in an axial direction by the rotating action of the cylindrical ring structure 52 so that the coolant gathers in the first and second radial passages 200,202. The rotating action generates hydraulic pressure within the radial passages 200,202.

In FIG. 14, the radially inner surface 67 of the cylindrical ring structure 52 extends in a direction that is substantially parallel to the rotational axis X. Therefore the internal diameters of the permanent magnet packages 54 are substantially constant. In other examples, the configuration of the radially inner surface 67 may be adapted to affect the hydraulic behaviour of the coolant during rotation. For example, the radially inner surface 67 of the cylindrical ring structure 52 could be configured to that at least a portion of it is inclined relative to the rotational axis X. The inclined surface, denoted as 67a in FIG. 14, may be beneficial in urging the coolant in an axial direction, either left or right, or in both directions, as shown in FIG. 14. Such an inclined surface would require somewhat more complex manufacturing and arrangement of the permanent magnet packages 54. Therefore, FIG. 15 illustrates a further option, which is that the radially inner surface 67 of the cylindrical ring structure 52 may be provided with a stepped profile relative to the rotational axis X.

This stepped radially inner surface is denoted as 67b in FIG. 15. Here, it will be appreciated that the stepped radially inner surface 67b is formed by permanent magnet packages 54 having different internal diameters. As such, a first group 54a of permanent magnet packages 54 have a smaller inner diameter than a second and third group 54b,54c of permanent magnet packages 54. The second and third groups 54b, c are located either side of the first group 54a of permanent magnet packages, when considered in the axial direction.

The effect of this configuration is that coolant that lands on the radially inner surface 67b is urged in a ‘downhill’ direction, towards the first and second radial passages 200,202, which thereby provide pressurised coolant sumps.

It should be noted that FIGS. 14 and 15 do not show the ridged profile of the radially inner surface 67 or the axial flow passages 100 through the cylindrical ring structure 52. However, this is for the purposes of clarity of the Figures, and it should be noted that the inclined and/or stepped radially inner surface 67a/b feature of these Figures may be combined with the ridged radially inner surface feature and/or the coolant passage features of the examples discussed above and illustrated in the previous Figures.

Many modifications may be made to the specific examples described above without departing from the scope of the invention as defined in the accompanying claims. Features of one embodiment may also be used in other embodiments, either as an addition to such embodiment or as a replacement thereof.

1. A generator rotor for a wind turbine, comprising a cylindrical ring structure defining a radially inner surface and a central hollow portion, and being arranged to rotate around a rotational axis (X), the cylindrical ring structure comprising:
a plurality of ring-shaped permanent magnet packages arranged coaxially around the rotational axis, the plurality of permanent magnet packages being adapted to form at least one coolant passage through the cylindrical ring structure,
wherein the cylindrical ring structure is adapted to serve as a sump for coolant, such that the sump is defined, at least in part, by the radially inner surface of the cylindrical ring structure,
wherein the cylindrical ring structure further comprises at least one coolant passage inlet that extends from the radially inner surface of the cylindrical ring structure to the at least one coolant passage,
and wherein at least one coolant passage outlet is arranged at one axial end of the cylindrical ring structure.

2. The generator rotor of claim 1,
wherein the at least one coolant passage inlet is formed at least in part by at least one of the plurality of permanent magnet packages.

3. The generator rotor of claim 1,
wherein the at least one coolant passage inlet is formed at least in part on a ring-shaped end plate of the cylindrical ring structure.

4. The generator rotor of claim 1, wherein the at least one coolant passage outlet comprises a restricted orifice that has a flow area less than 20% of the average flow area of the at least one coolant passage.

5. The generator rotor of claim 1, wherein the at least one coolant passage outlet is defined in a ring-shaped end plate of the cylindrical ring structure.

6. The generator rotor of claim 5, wherein the ring-shaped end plate is provided with at least one manifold volume to control the flow direction of coolant from at least one of the at least one coolant passage.

7. The generator rotor of claim 6, wherein the at least one manifold volume is adapted to direct coolant to flow from one of the at least one cooling passage to another one of the at least one cooling passage

8. The generator rotor of claim 1, wherein the at least one coolant passage extends in a generally axial direction of the generator rotor along at least a part of the cylindrical ring structure.

9. The generator rotor of claim 1, wherein the at least one coolant passage is formed at least in part by magnet pockets provided in the permanent magnet packages.

10. The generator rotor of claim 1, claims, wherein the at least one coolant passage is formed at least in part proximate the radially inner surface defined by the permanent magnet packages.

11. The generator rotor of claim 10, wherein the at least one coolant passage is defined at least in part at a radially inner margin of the permanent magnet packages that has a radial height that is less than 20% of the radial height of the permanent magnet packages.

12. The generator rotor of claim 1, wherein said sump is defined, at least in part, by the radially inner surface of the plurality of ring-shaped permanent magnet packages.

13. The generator rotor of claim 1, wherein the radially inner surface is adapted to define a plurality of ridges.

14. The generator rotor of claim 13, wherein the plurality of ridges are parallel with the rotational axis (X) of the rotor.

15. The generator rotor of claim 13, wherein the plurality of ridges extend circumferentially about the radially inner surface.

16. The generator rotor of claim 13, wherein the radial height of the ridges is less than 20% of the radial height of the plurality of permanent magnet packages.

17. The generator rotor of claim 13, wherein the plurality of ridges provide a smoothly undulating profile.

18. A generator for a wind turbine, the generator including a stator including stator windings at a radially outer position and the generator rotor of claim 1 adapted to be rotatable within a volume radially inward of the stator windings.

19. The generator of claim 18, comprising a coolant system adapted to direct coolant at the radially inner surface of the cylindrical ring structure.

20. The generator of claim 19, wherein the coolant system comprises at least one spray nozzle adapted to spray coolant towards the radially inner surface.

21. The generator of claim 20, wherein the at least one spray nozzle is mounted in a stationary reference frame with respect to the generator rotor.

22. A wind turbine comprising the generator of claim 18.
